(19) United States
(12) Patent Application Publication
(10) Pub. No.: US 2024/0377897 A1
(43) Pub. Date: Nov. 14, 2024

(54) INPUT APPARATUS, INPUT SYSTEM AND INPUT METHOD

(71) Applicant: NIPPON TELEGRAPH AND TELEPHONE CORPORATION, Tokyo (JP)

(72) Inventors: Ryosuke AOKI, Tokyo (JP); Yuki KUBO, Tokyo (JP); Yukio KOIKE, Tokyo (JP)

(21) Appl. No.: 18/691,622

(22) PCT Filed: Oct. 5, 2021
(86) PCT No.: PCT/JP2021/036826

§ 371 Date: Mar. 13, 2024

(51) Int. Cl. G06F 3/033

(52) U.S. Cl. CPC G06F 3/033

(57) ABSTRACT

An input device includes: an operation unit including a plurality of protrusions and configured to receive an operation by a body of an operator; a sensor configured to measure a 3-dimensional pressure value pressed by the plurality of protrusions; and a pressing operation unit configured to press the sensor through an operation by the body of the operator independently of the operation unit.

### TECHNICAL FIELD

The present invention relates to an input device, an input system, and an input method.

### BACKGROUND ART

Input devices such as pointing sticks or touch pads operating cursors on displays in accordance with motions of fingers have been developed. Also, input devices such as touch screens in which icons are able to be operated the screen being directly touched with the finger have been developed. However, it is difficult for people whose upper limb functions are paralyzed due to cervical spinal cord injury, especially those with paralysis of the entire flexor digitorum muscles, or the finger flexor muscles, to handle the above-mentioned input devices.

People whose upper limb functions are paralyzed move mouses placed apart from keyboards with both their hands or rotate track balls many times with their arms to perform cursor operations. People whose whole finger extension and finger bending muscles are paralyzed perform touching operations in a time-consuming manner. In order to perform smartphone operations in public spaces, it is necessary to perform touching operations after moving to positions at which people do not interfere with neighboring people.

In recent years, an input device in which a display operation is performed by wearing a wearable touch pad on one arm and touching the touch pad with a finger which is not moved by the movement of the other arm, and an input device that performs a display operation by fixing the wearable touch pad on a wheelchair and touching the touch pad with a finger which is not moved by the movement of the arm have been examined (Non Patent Literature 1). Accordingly, an input device can be installed at a position at which a display is easy to see and easy to operate.

### CITATION LIST

### Non Patent Literature

Non Patent Literature 1: Meethu Malu, and Leah Findlater, “Personalized, Wearable Control of a Head-mounted Display for Users with Upper Body Motor Impairments”, SIGCHI2015

### SUMMARY OF INVENTION

### Technical Problem

However, the touch pad operation with a paralyzed upper limb has not been improved and, in addition, a touch pad which requires a certain size to some extent to improve operability is likely to be obstructed daily operations. Accordingly, for a paralyzed upper limb, a small input device in which a cursor operation on the display can be performed with a small motion without disturbing daily operations is required. Further, it is preferable that a limb handicapped person can suitably attach and use an input device to a personal belonging so that the input device can be used in various environments such as public spaces and offices.

An object of the disclosed technology is to improve operability of an input device.

### Solution to Problem

According to the disclosed technology, an input device includes: an operation unit including a plurality of protrusions and configured to receive an operation by a body of an operator; a sensor configured to measure a 3-dimensional pressure value pressed by the plurality of protrusions; and a pressing operation unit configured to press the sensor through an operation by the body of the operator independently of the operation unit.

### Advantageous Effects of Invention

It is possible to improve operability of the input device.

### BRIEF DESCRIPTION OF DRAWINGS

FIG. 1 is a diagram illustrating a system configuration example of an input system.

FIG. 2 is a perspective view illustrating an example of the input device.

FIG. 3 is a top view illustrating an example of the input device.

FIG. 4 is a sectional view illustrating an example of the input device.

FIG. 5 is a perspective view illustrating a structure of the lower surface of the input device.

FIG. 6 is a perspective view illustrating an example of an elastic unit included in the input device.

FIG. 7 is a perspective view illustrating an example of a sensor included in the input device.

FIG. 8 is a diagram illustrating a functional configuration example of an information processing device.

FIG. 9 is a flowchart illustrating an example of a flow of measured value processing according to Example 1.

FIG. 10 is a flowchart illustrating an example of a flow of measured value processing according to Example 2.

FIG. 11 is a diagram illustrating an example of a hardware configuration of a computer.

### DESCRIPTION OF EMBODIMENTS

An embodiment of the present invention (present embodiment) will be described below with reference to the drawings. The embodiment to be described below is merely exemplary, and embodiments to which the present invention is applied are not limited to the following embodiment.

### Overview of Present Embodiment

An input system according to the present embodiment includes an input device and an information processing device. An input device including a depressed operation unit transmits data indicating a measured value by a 3-dimensional pressure sensor installed on the bottom of the operation unit to the information processing device. The information processing device performs display control such that a cursor displayed on a screen is moved based on the measured value shown in the received data.

### System Configuration Example of Input System

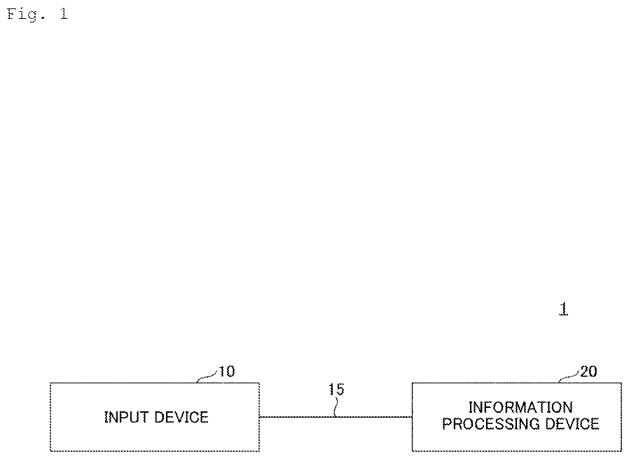

FIG. 1 is a diagram illustrating a system configuration example of the input system. An input system 1 includes an input device 10 and an information processing device 20.

The input device 10 and the information processing device 20 are communicatively connected to each other via a communication line 15 or the like. A communication method between the input device 10 and the information processing device 20 may be wired or wireless.

The input device 10 has a recessed operation unit and transmits data indicating a measured values by a 3-dimensional pressure sensor installed on the bottom of the operation unit to the information processing device at regular intervals via the communication line 15 or the like.

The information processing device 20 is a tablet terminal, a personal computer (PC), a glasses-type display, or the like and is an operation target device. The information processing device 20 performs display control on a display or the like such that a cursor displayed on a screen is moved or a selection menu is changed based on the measured value shown in the received data.

### Structure of Input Device

Next, a structure of the input device 10 will be described with reference to the drawings.

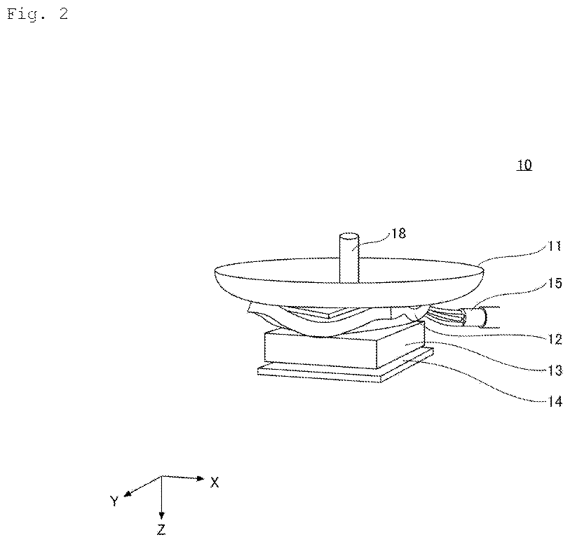

FIG. 2 is a perspective view illustrating an example of the input device. The input device 10 includes an operation unit 11, an elastic unit 12, a sensor casing 13, an installation surface fixing unit 14, and a pressing operation unit 18.

The operation unit 11 is configured as a recessed member, and is mainly pressed in the Z axis positive direction by the body (a hand, a finger, or the like) of an operator. When the input device 10 is installed on a table or the like, the Z axis positive direction is a direction close to the downward perpendicular direction in the installation state.

The elastic unit 12 is an elastic member that inhibits the operation unit 11 from being separated from the sensor when a force is applied to the operation unit 11.

The sensor casing 13 is a casing in which a 3-dimensional pressure sensor is housed.

The installation surface fixing unit 14 is a member fixing an installation surface in the installation state when the input device 10 is installed on a table or the like. The installation surface fixing unit 14 is configured with, for example, an earthquake resistant gel or the like absorbing vibration.

The communication line 15 is connected to a 3-dimensional pressure sensor housed in the sensor casing 13.

The pressing operation unit 18 is configured with a rod-like member and is located at the center of an XY plane of the operation unit 11. The pressing operation unit 18 is directly mounted on the sensor with the elastic unit 12 interposed therebetween and can operate independently of the operation unit 11.

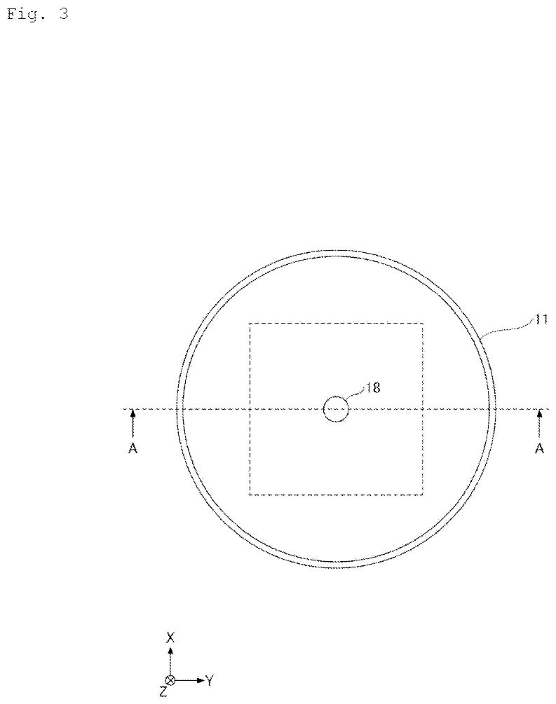

FIG. 3 is a top view illustrating an example the input device. The operation unit 11 is circular when viewed from an upper surface in the Z axis negative direction. In a coordinate system to be described below, a sensor surface is an XY plane, and the center of the circle of the operation unit 11 in the XY plane is the origin.

The pressing operation unit 18 extends in a direction along the Z axis at the center of the circle of the operation unit 11. The pressing operation unit 18 may be cylindrical or prismatic, or may have a shape such as a spherical shape or an ellipsoid other than a rod-like shape.

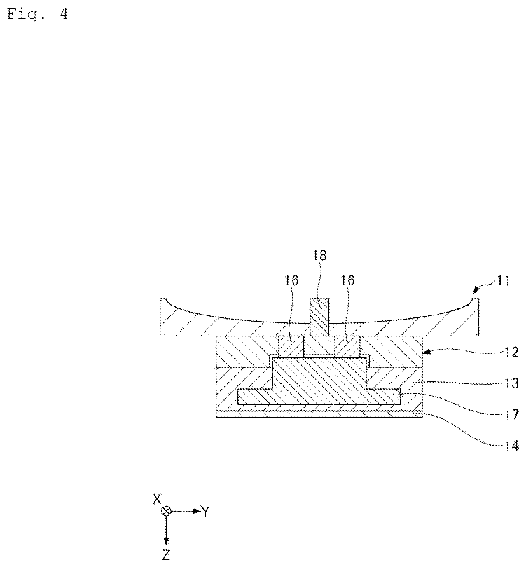

FIG. 4 is a sectional view illustrating an example of the input device. FIG. 4 is a sectional view taken along the line A-A of FIG. 3. The operation unit 11 includes a protrusion 16 pressing the sensor 17. The protrusions 16 are brought into contact with the sensor 17 and press the sensor 17 in the Z axis positive direction. The protrusions 16 may be brought into direct contact with the sensor 17 or may be configured to press the sensor 17 with the elastic unit 12 interposed therebetween so that the protrusions 16 are not brought into direct contact with the sensor 17.

The sensor 17 is a 3-dimensional pressure sensor housed in the sensor casing 13 and measures a pressure from the four protrusions 16.

The pressing operation unit 18 is configured to press the sensor 17 with the elastic unit 12 interposed therebetween. The operation unit 11 has a through-hole through which the pressing operation unit 18 penetrates.

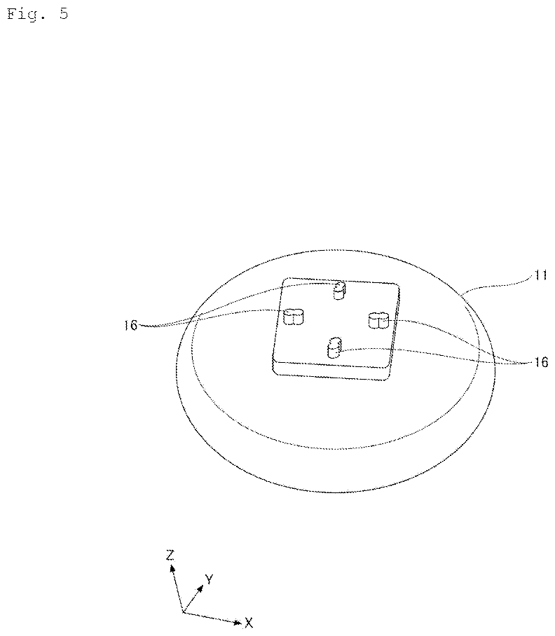

FIG. 5 is a diagram illustrating a configuration of the input device. The operation unit 11 includes the protrusions 16 at four positions slightly separated from the center of a circle formed by the operation unit 11 in the vertical and horizontal directions. The four protrusions 16 enables a force to be appropriately applied in eight directions (up, down, left, and right and four diagonal directions) in an input of the sensor 17 which is a small 3-dimensional pressure sensor. The sensor 17 measures pressure values (Px, Py, Pz) in the X, Y and Z directions.

The number of protrusions 16 described above is exemplary may be any number. That is, the operation unit 11 includes the plurality of protrusions 16, and is operated by a body of the operator. The sensor 17 measures 3-dimensional pressure values pressed by the plurality of protrusions.

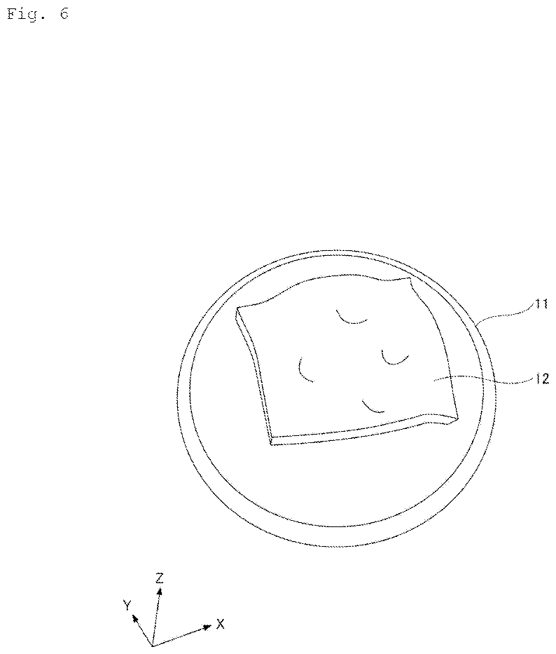

FIG. 6 is a perspective view illustrating an example of the elastic unit included in the input device. In the example illustrated in FIG. 6, the elastic unit 12 is formed to cover the protrusions 16. Accordingly, even when mutually different forces are applied to the four protrusions 16, an inclination of the operation unit 11 is absorbed by the elastic unit 12. Therefore, a state in which the protrusions 16 can press the sensor 17 is kept.

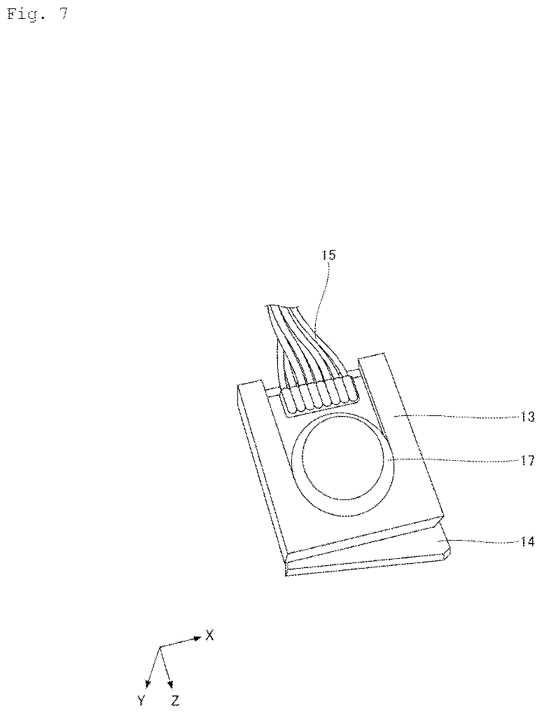

FIG. 7 is a perspective view illustrating an example of a sensor included in the input device. The sensor 17 is housed in the sensor casing 13 and is connected to the communication line 15. The sensor casing 13 has an installation surface fixed to an installation target such as a table in an installation state by the installation surface fixing unit 14.

### Functional Configuration Example of Information Processing Device

Next, a function of the information processing device 20 will be described.

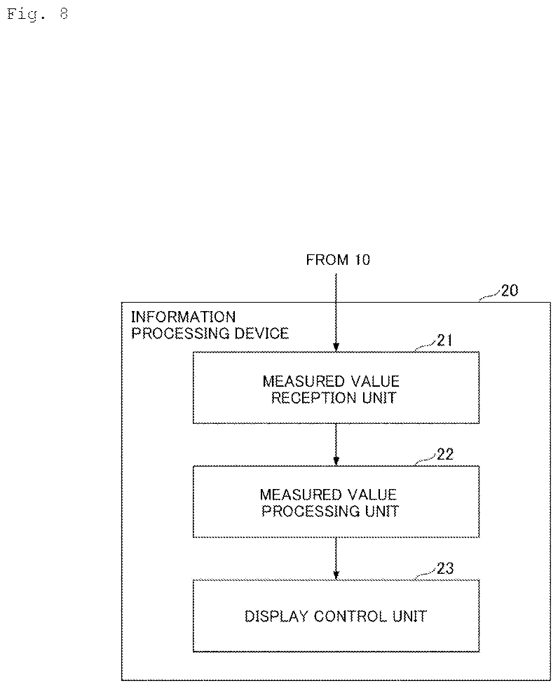

FIG. 8 is a diagram illustrating a functional configuration example of the information processing device. The information processing device 20 includes a measured value reception unit 21, a measured value processing unit 22, and a display control unit 23.

The measured value reception unit 21 receives data (hereinafter referred to as measured data) indicating measured values (Px, Py, Pz) from the input device 10.

The measured value processing unit 22 performs processing for a screen operation such as movement of a cursor and a change in a selection menu based on the measured value.

The display control unit 23 performs display control on a display or the like such that processing results by the measured value processing unit 22 are reflected.

### Operation Example of Information Processing Device

An operation of the information processing device 20 will be described below. The information processing device 20 starts measured value processing by receiving data indicating a measured value periodically, for example, every second, from the input device 10.

Examples 1 and 2 will be described below as specific examples of the measured value processing. Example 1 is an example in which a cursor operation is performed based on measured values. Example 2 is an example in which a cursor operation, a drag operation, or a range selection operation is performed based on measured values.

### Flow of Measured Value Processing According to Example 1

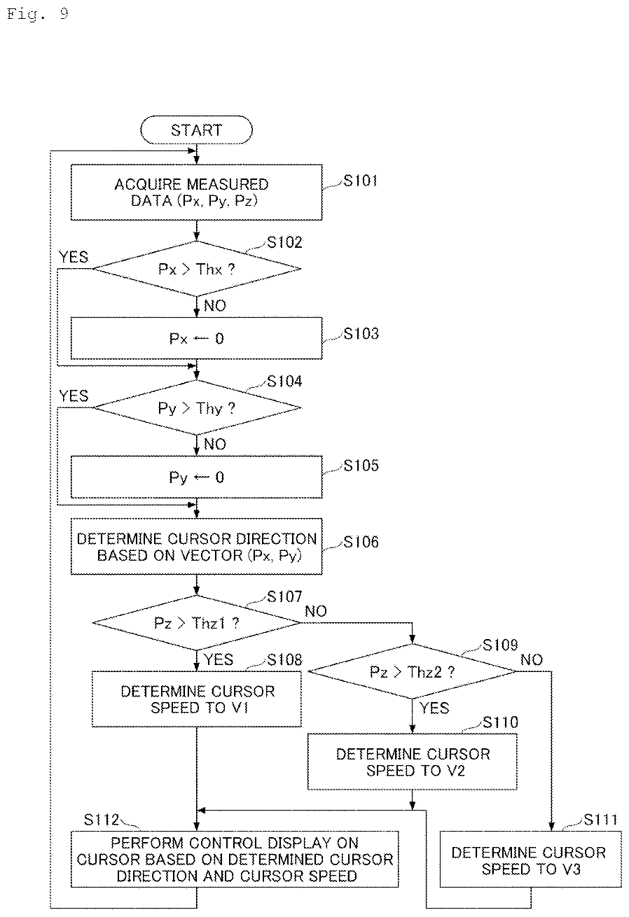

FIG. 9 is a flowchart illustrating an example of a flow of the measured value processing according to Example 1. The measured value processing unit 22 acquires measured data (Px, Py, Pz) (step S101). Subsequently, the measured value processing unit 22 determines whether the measured value Px is greater than a threshold Thx (step S102).

When it is determined that the measured value Px is not greater than the threshold Thx (No in step S102), the measured value processing unit 22 substitutes 0 into the variable Px indicating the measured value (step S103).

Conversely, when it is determined that the measured value Px is greater than the threshold Thx (Yes in step S102), the measured value processing unit 22 skips processing of step S103.

Subsequently, the measured value processing unit 22 determines whether the measured value Py is greater than a threshold Thy (step S104).

When it is determined that the measured value Py is not greater than the threshold Thy (No in step S104), the measured value processing unit 22 substitutes 0 into the variable Py indicating the measured value (step S105).

Conversely, when it is determined that the measured value Py is greater than the threshold Thy (Yes in step S104), the measured value processing unit 22 skips processing of step S105.

Subsequently, the measured value processing unit 22 determines a cursor direction based on the vector (Px, Py) (step S106). Specifically, the measured value processing unit 22 determines a direction of the vector (Px, Py), that is, the direction of the vector (Px, Py) to a direction of a line segment oriented from the origin O to the point (Px, Py).

Subsequently, the measured value processing unit 22 determines whether the measured value Pz is greater than a threshold Thz1 (step S107). When it is determined that the measured value Pz is greater than the threshold Thz1 (Yes in step S107), the measured value processing unit 22 determines a cursor speed to V1 (step S108).

When it is determined that the measured value Pz is not greater than the threshold Thz1 (No in step S107), the measured value processing unit 22 determines whether the measured value Pz is greater than a threshold Thz2 (step S109).

When it is determined that the measured value Pz is greater than the threshold Thz2 (Yes in step S109), the measured value processing unit 22 determines the cursor speed to V2 (step S108).

Conversely, when it is determined that the measured value Pz is not greater than the threshold Thz2 (No in step S109), the measured value processing unit 22 determines the cursor speed to V3 (step S111).

The measured value processing unit 22 performs display control on the cursor based on the determined cursor direction and cursor speed after step S108, S110, or S111 (step S112).

The thresholds Thx, Thy, Thz1, Thz2, and the speeds V1, V2, and V3, and the like are predefined reference values according to operability of the cursor, muscle strength of the operator, the degree of the limb handicap, or the like.

As described above, the measured value processing unit 22 according to the present example determines the cursor direction in accordance with the measured values Px and Py, and determines the cursor speed in accordance with the measured value Pz.

### Flow of Measured Value Processing According to Example 2

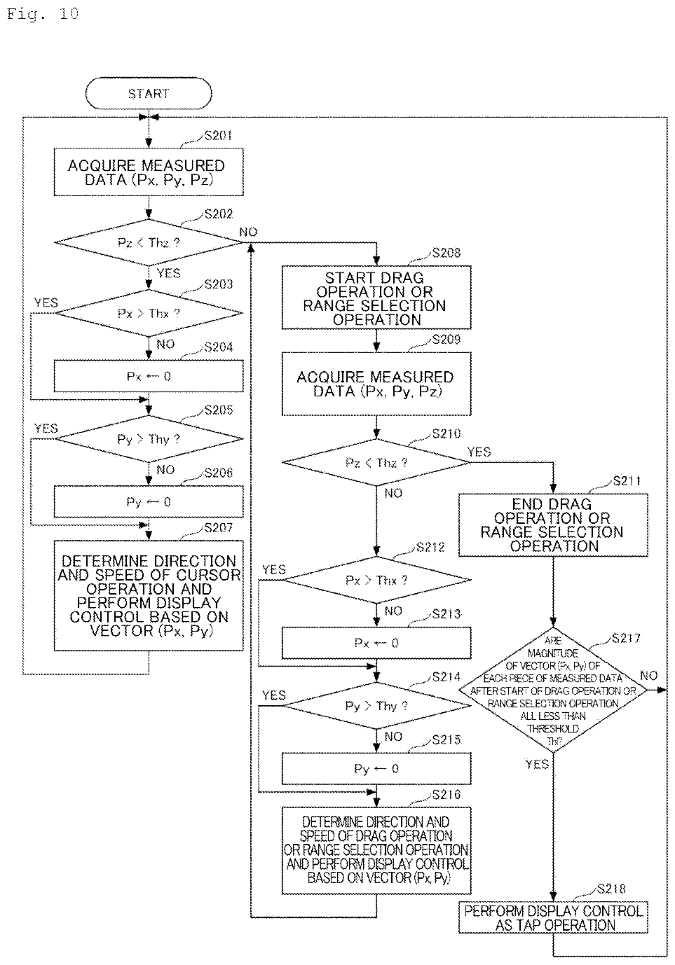

FIG. 10 is a flowchart illustrating an example of a flow of measured value processing according to Example 2. The measured value processing unit 22 acquires measured data (Px, Py, Pz) (step S201). Subsequently, the measured value processing unit 22 determines whether the measured value Pz is less than a threshold Thz (step S202).

When it is determined that the measured value Pz is less than the threshold Thz (Yes in step S202), the measured value processing unit 22 determines whether the measured value Px is greater than the threshold Thx (step S203).

When it is determined that the measured value Px is not greater than the threshold Thx (No in step S203), the measured value processing unit 22 substitutes 0 into the variable Px indicating the measured value (step S204).

Conversely, when it is determined that the measured value Px is greater than the threshold Thx (Yes in step S203), the measured value processing unit 22 skips processing of step S204.

Subsequently, the measured value processing unit 22 determines whether the measured value Py is greater than a threshold Thy (step S205).

When it is determined that the measured value Py is not greater than the threshold Thy (No in step S205), the measured value processing unit 22 substitutes 0 into the variable Py indicating the measured value (step S206).

Conversely, when it is determined that the measured value Py is greater than the threshold Thy (Yes in step S205), the measured value processing unit 22 skips processing of step S206.

Then, the measured value processing unit. 22 determines a direction and a speed of the cursor operation based on the vector (Px, Py) and performs display control (step S207). Specifically, the measured value processing unit 22 determines the direction of the vector (Px, Py) as the direction of the cursor and determines the speed of the cursor based on magnitude of the vector (Px, Py).

The measured value processing unit 22 may calculate the speed of the cursor by multiplying the magnitude of the vector (Px, Py) by a predetermined coefficient or may determine the speed of the cursor step by step in accordance with a result obtained in comparison with a predetermined threshold.

Conversely, when it is determined that the measured value Pz is not less than the threshold The (No in step S202), the measured value processing unit 22 starts a drag operation or a range selection operation. Here, the measured value processing unit 22 determines a start operation in accordance with whether an operation target cursor comes into contact with an icon or the like on the screen. For example, the measured value processing unit 22 starts a drag operation when the cursor comes into contact with an icon or the like, and starts a range selection operation when the cursor does not come into contact with the icon or the like.

Subsequently, the measured value processing unit 22 further acquires measured data (Px, Py, Pz) (step S209). Subsequently, the measured value processing unit 22 determines whether the measured value Pz is less than the threshold Thz (step S210).

When it is determined that the measured value Pz is less than the threshold Thz (Yes in step S210), the measured value processing unit 22 terminates the drag operation or the range selection operation (step S211).

Subsequently, the measured value processing unit 22 determines whether the magnitude of the vector (Px, Py) of each piece of measured data after the start of the drag operation or the range selection operation is all less than a threshold Thl (step S217). The threshold Thl is a reference value predefined in advance in accordance with the operability of the cursor, the muscle strength of the operator, the degree of the limb handicap, or the like.

When the measured value processing unit 22 determines that the magnitude of the vector (Px, Py) of each piece of measured data after the start of the drag operation or the range selection operation is all less than the threshold Thl (Yes in step S217), the display control unit 23 performs the display control as the tap operation (step S218). Then, the measured value processing unit 22 returns the processing to step S201.

When the measured value processing unit 22 determines that the magnitude of the vector (Px, Py) of each piece of measured data after the start of the drag operation or the range selection operation is all not less than the threshold Thl (No in step S217), the processing returns to the processing of step S201.

When it is determined that the measured value Pz is not less than the threshold Thz (No in step S210), the measured value processing unit 22 determines whether the measured value Px is greater than the threshold Thx (step S212).

When it is determined that the measured value Px is not greater than the threshold Thx (No in step S212), the measured value processing unit 22 substitutes 0 into the variable Px indicating the measured value (step S213).

Conversely, when it is determined that the measured value Px is greater than the threshold Thx (Yes in step S212), the measured value processing unit 22 skips the processing of step S213.

Subsequently, the measured value processing unit 22 determines whether the measured value Py is greater than the threshold Thy (step S214).

When it is determined that the measured value Py is not greater than the threshold Thy (No in step S214), the measured value processing unit 22 substitutes 0 into the variable Py indicating the measured value (step S215).

When the measured value Py is determined to be greater than the threshold Thy (Yes in step S214), the measured value processing unit 22 skips the processing of step S215.

Then, the measured value processing unit 22 determines the direction and speed of the drag operation or the range selection operation based on the vector (Px, Py), and the display control unit 23 performs the display control (step S216).

Specifically, the measured value processing unit 22 determines the direction of the vector (Px, Py) as the direction of drag operation or range selection operation and determines the speed of the drag operation or the range selection operation based on the magnitude of the vector (Px, Py). Then, the measured value processing unit 22 returns the processing to step S208.

As described above, the measured value processing unit 22 according to the present example determines whether the cursor operation, the drag operation, or the range selection operation is performed in accordance with the measured value Pz, and determines the direction and speed of the operation in accordance with the measured values Px and Py.

When the measured value processing unit 22 determines that the measured value Pz is measured and the values of the measured values Px and Py are small, the display control unit 23 performs the display control as the tap operation. The above-described tap operation may be a click operation, a pressing operation, or the like and is used, for example, as an operation for selecting an icon displayed on the screen and opening an application program.

This operation is implemented by inhibiting a pressure in the Px and Py directions to the sensor 17 by operating the pressing operation unit 18 by a user, and applying the pressure in the Pz direction.

The flow of the measured value processing according to each of the above-described examples may be one example or another example. For example, in the measured value processing according to Example 2, measured value processing unit 22 may fix the state of the cursor operation or the drag operation when the measured value Px exceeds the threshold Thx and the measured value Py exceeds the threshold Thy.

### Hardware Configuration Example According to Present Embodiment

The information processing device 20 can be implemented, for example, by causing a computer to execute a program describing processing content described in the present embodiment. The “computer” may be a physical machine or a virtual machine on a cloud. When a virtual machine is used, “hardware” described here is virtual hardware.

The program can be stored and distributed by being recorded in a computer-readable recording medium (a portable memory or the like). The program can also be provided through a network such as the Internet or an electronic mail.

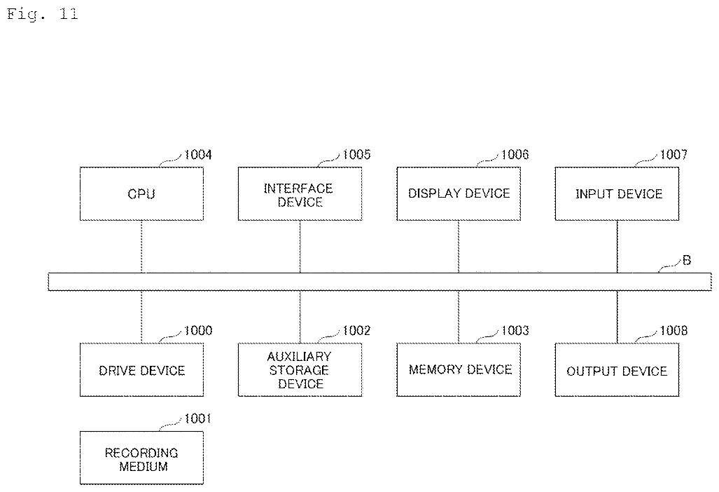

FIG. 11 is a diagram illustrating a hardware configuration example of the computer. The computer illustrated in FIG. 11 includes a drive device 1000, an auxiliary storage device 1002, a memory device 1003, a CPU 1004, an interface device 1005, a display device 1006, an input device 1007, and an output device 1008 connected to each other via a bus B.

The program implementing the processing in the computer is provided by, for example, a recording medium 1001 such as a CD-ROM or a memory card. When the recording medium 1001 storing the program is set in the drive device 1000, the program is installed from the recording medium 1001 to the auxiliary storage device 1002 through the drive device 1000. However, the program need not necessarily be installed from the recording medium 1001 and may be downloaded from another computer via a network. The auxiliary storage device 1002 stores the installed program and also stores necessary files, data, and the like.

The memory device 1003 reads and stores the program from the auxiliary storage device 1002 when an instruction to start the program is given. The CPU 1004 implements a function related to the device in accordance with the program stored in the memory device 1003. The interface device 1005 is used as an interface for connection to a network. The display device 1006 displays a graphical user interface (GUI) and the like according to the program. The input device 1007 is configured with a keyboard and a mouse, buttons, a touch panel, or the like and is used to input various operation instructions. The output device 1008 outputs a calculation result. The computer may include a graphic processing unit (GPU) or a sensor processing unit (TPU) instead of the CPU 1004 or may include a GPU or a TPU in addition to the CPU 1004. In that case, for example, processing may be divided and executed in such a way that the GPU or the TPU executes processing that requires special arithmetic operations, and that the CPU 1004 executes other processing.

### Advantageous Effect of Present Embodiment

In the input system 1 according to the present embodiment, an input device including a depressed operation unit transmits data indicating a measured value by a 3-dimensional pressure sensor installed at the bottom of the operation unit to an information processing device. The information processing device performs display control such that a cursor displayed on the screen is moved based on the measured value shown in the received data. Accordingly, it is possible to improve operability of the input device.

For example, the measured value processing unit 22 may determine a direction of the cursor in accordance with the measured values Px and Pz and determine a cursor speed in accordance with the measured value Pz. Accordingly, the direction and strength of the cursor operation can be adjusted through a small operation such as a paralyzed upper limb or the like.

When the measured value Pz is equal to or more than the threshold Thz, the measured value processing unit 22, determines whether to perform a drag operation or a range selection operation or a tap operation in accordance with the magnitude of the vector (Px, Py). Accordingly, it is possible to implement the tap operation using the pressing operation unit 18.

Further, the measured value processing unit 22 may determine to perform the cursor operation, the drag operation, or the range selection operation in accordance with the measured value Pz, and determine the direction and speed of the operation in accordance with the measured values Px and Pz. Accordingly, the drag operation such as a track point of the related art does not require an icon selection by the touch pad, and the cursor operation and the drag operation can be compatible through an operation of only the input device 10.

### Conclusion of Embodiment

The present specification describes an input device, an input system, and an input method described in at least each of the following clauses.

### Clause 1

An input device including:
an operation unit including a plurality of protrusions and configured to receive an operation by
a body of an operator;
a sensor configured to measure a 3-dimensional pressure value pressed by the plurality of protrusions; and
a pressing operation unit configured to press the sensor through an operation by the body of the operator independently of the operation unit.

### Clause 2

The input device according to Clause 1, further including an elastic unit configured to absorb an inclination of the operation unit.

### clause 3

The input device according to Clause 1 or 2, further including an installation surface fixing unit configured to fix an installation surface to an installation object in an installation state.

### Clause 4

An input system including an input device and an information processing device,
wherein the input device includes
an operation unit that includes a plurality of protrusions and receives an operation by a body of an operator,
a sensor that measures a 3-dimensional pressure value pressed by the plurality of protrusions, and
a pressing operation unit that presses the sensor through an operation by the body of the operator independently of the operation unit, and
wherein the information processing device includes a measured value reception unit that receives data indicating a measured value from the input device, and
a measured value processing unit that performs processing for a screen operation based on the measured value.

### Clause 5

The input system according to Clause 4,
wherein the measured value includes pressure values in X, Y, and Z directions, and
wherein the measured value processing unit determines a cursor direction in accordance with the pressure values in the X and Y directions and determines a cursor speed in accordance with the pressure value in the Z direction.

### Clause 6

The input system according to Clause 4,
wherein the measured value include pressure values in X, Y, and Z directions, and
wherein the measured value processing unit determines whether to perform a drag operation, a range selection operation, or a tap operation in accordance with magnitude of a vector of the pressure values in the X and Y directions when the pressure value in the Z direction is equal to or greater than a threshold.

### Clause 7

The input system according to Clause 6, wherein the measured value processing unit determines whether to perform a cursor operation, a drag operation, or a range selection operation in accordance with the pressure value in the 2-direction, and determines a direction and a speed of the operation in accordance with the pressure values in the X and Y directions.

### Clause 8

An input method performed by an input system including an input device and an information processing device,
wherein the input device include:
an operation unit that includes a plurality of protrusions and receives an operation by a body of an operator,
a sensor that measures a 3-dimensional pressure value pressed by the plurality of protrusions, and
a pressing operation unit that presses the sensor through an operation by the body of the operator independently of the operation unit, and
wherein the input method comprises:
a step of receiving data indicating a measured value from the input device by the information processing device; and
a step of performing processing for a screen operation based on the measured value by the information processing device.

Although the present embodiment has been described above, the present invention is not limited to such a specific embodiment and various modifications and changes are possible within the scope of the gist of the present invention described in the claims.

### REFERENCE SIGNS LIST

1 Input system
10 Input device
11 Operation unit
12 Elastic unit
13 Sensor casing
14 Installation surface fixing unit
15 Communication line
16 Protrusion unit
17 Sensor
18 Pressing operation unit
20 Information processing device
21 Measured value reception unit
22 Measured value processing unit
23 Display control unit
1000 Drive device
1001 Recording medium
1002 Auxiliary storage device
1003 Memory device
1004 CPU
1005 Interface device
1006 Display device
1007 Input device
1008 Output device

1. An input device comprising:
an operation unit including a plurality of protrusions and configured to receive an operation by a body of an operator;
a sensor configured to measure a 3-dimensional pressure value pressed by the plurality of protrusions; and
a pressing operation unit configured to press the sensor through an operation by the body of the operator independently of the operation unit.

2. The input device according to claim 1, further comprising an elastic unit configured to absorb an inclination of the operation unit.

3. The input device according to claim 1, further comprising an installation surface fixing unit configured to fix an installation surface to an installation object in an installation state.

4. An input system comprising an input device and an information processing device,
wherein the input device includes
an operation unit that includes a plurality of protrusions and receives an operation by a body of an operator,
a sensor that measures a 3-dimensional pressure value pressed by the plurality of protrusions, and
a pressing operation unit that presses the sensor through an operation by the body of the operator independently of the operation unit, and
wherein the information processing device includes
a processor; and
a memory storing program instructions that cause the processor to:
receive data indicating a measured value from the input device, and
perform processing for a screen operation based on the measured value.

5. The input system according to claim 4,
wherein the measured value includes pressure values in X, Y, and Z directions, and
wherein the program instructions cause the processor to determine a cursor direction in accordance with the pressure values in the X and Y directions and determine a cursor speed in accordance with the pressure value in the Z direction.

6. The input system according to claim 4,
wherein the measured value include pressure values in X, Y, and Z directions, and
wherein the program instructions cause the processor to determine whether to perform a drag operation, a range selection operation, or a tap operation in accordance with magnitude of a vector of the pressure values in the X and Y directions when the pressure value in the Z direction is equal to or greater than a threshold.

7. The input system according to claim 6, wherein the program instructions cause the processor to determine whether to perform a cursor operation, a drag operation, or a range selection operation in accordance with the pressure value in the Z-direction, and determines a direction and a speed of the operation in accordance with the pressure values in the X and Y directions.

8. An input method performed by an input system including an input device and an information processing device,
wherein the input device include:
an operation unit that includes a plurality of protrusions and receives an operation by a body of an operator,
a sensor that measures a 3-dimensional pressure value pressed by the plurality of protrusions, and
a pressing operation unit that presses the sensor through an operation by the body of the operator independently of the operation unit, and
wherein the input method comprises:
receiving data indicating a measured value from the input device by the information processing device; and
performing processing for a screen operation based on the measured value by the information processing device.
